(19) United States
(12) Patent Application Publication
(10) Pub. No.: US 2003/0056754 A1
(43) Pub. Date: Mar. 27, 2003

(54) Engine shutdown valve

(76) Inventor: Dean Stephen Prysko, Edmonton (CA)

Correspondence Address: John Russell Uren, P. Eng., 1590 Bellevue Avenue, Suite 202, West Vancouver, BC, V7V 1A7, CA

(21) Appl. No.: 09/963,792

(22) Filed: Sep. 24, 2001

(51) Int. Cl. F02D 1/00

(52) U.S. Cl. 123/394

(57) ABSTRACT

An engine shutdown valve for terminating air flow to a diesel engine and thereby shutting down the engine. The shutdown valve is an integral casting and comprises the valve body and associated nozzles. A land is machined on the valve body for attachment directly to the flange of a solenoid. A spindle assembly has a spindle with a flange and an associate spacer for retaining a compression spring between respective shoulders on said flange and spacer. The spindle has an area within the spring of a significantly smaller diameter thereby to avoid contact with the spring during operation.

### INTRODUCTION

This invention relates to an engine shutdown valve and, more particularly, to a shutdown valve which is used for terminating air flow in a diesel engine thereby to terminate operation of the engine.

### BACKGROUND OF THE INVENTION

The use of shutdown valves to terminate air flow and thereby terminate operation of an engine is known and many such valves have been designed and utilised for this purpose. Such shutdown valves are generally used as safety devices since the use of diesel engines in areas where airborne hydrocarbons are present may result in such hydrocarbons being drawn into the air intake and causing the engines to accelerate out of control with the concomitant risk of explosion and fire. Examples of such valves are disclosed and claimed in our U.S. Pat. Nos. 5,205,252, 4,537,386 and 4,285,494 which teach a linear or non-rotary movement of the gate for for the shutdown valve. Rotary movement of gates about an axis in shutdown valves is disclosed, for example, in our further and earlier U.S. Pat. Nos. 6,032,921, 5,205,252 and 5,203,536. The devices disclosed in all of these patents are useful in certain applications but they also include deficiencies which it is the intention of the present invention to reduce or overcome. All of such engine shutdown valves are sold under the trademark RIGSAVER and have been used for many years in various applications.

The deficiencies of some of such earlier engine shutdown valves relate to the fit of the shutdown valve within the air supply duct or ducts through which air is provided to the diesel engine by way of turbo charger or otherwise. These prior art valves generally included a body and two individual and separate nozzles, one on each side of the body, which nozzles were press fitted into the body prior to the installation of the shut down valve in the air supply duct leading from the turbo charger to the engine. The body had a counterbore on each side to which the nozzles were press fitted by raising the temperature of the body. An adhesive was then applied to the counterbore to assist in retaining the nozzles and to provide a pneumatic seal following assembly. The nozzles were then press fitted at room temperature into the body held at an elevated temperature.

One problem with the assembly, however, was that diesel engines are often run under high temperature and severe operating conditions resulting in shocks and expansions and contractions to the assembled valve and nozzles. The nozzles, under such conditions, would begin to separate from the body which caused air leakage and, eventually, nozzle blow out could occur. These conditions were hazardous operating conditions.

A further problem with the engine shutdown valves according to the prior art related to the assembly of the solenoid and its associated plunger and spindle within the shutdown valve. Previously, a first flange was operable fitted to the solenoid body and a second flange was operably fitted to the valve body. Capscrews were used to assemble the two flanges and the solenoid to the valve body. The reason for such multiple flanges was an attempt to use an engine shutdown valve of a single design in multiple applications. While the objective was useful, there were problems with tolerance buildup using the multiple flange type assembly. This tolerance buildup created various interferences during valve operation which created drag on the spindle and which compromised the proper operation of gate release. This, in turn, compromised the proper shutdown of the engine if such shutdown was desired.

Yet a further problem with the engine shutdown valves according to the prior art related to the design of the spindle assembly itself. The previous design utilised a spindle having an outside diameter. A compression return spring was positioned and used for returning the spindle to its position holding the gate of the shutdown valve in its open or unreleased position. A flange was provided between the return spring and a plunger. The outside diameter of the spindle was unnecessarily large with the result that the return spring would contact the spindle creating drag which compromised proper valve operation. A further and more serious problem was that since the flange supported the spring itself and that the inside diameter of the flange was somewhat larger than the outside of the spindle, the return spring could actually work its way into the space between the flange and spindle thereby creating a possible jamming action which could terminate proper spindle operation which again compromised the proper shutdown of the engine thereby creating safety problems.

### SUMMARY OF THE INVENTION

According to one aspect of the invention, there is provided an engine shutdown valve having a body with an air passage therein and at least one nozzle on one side of said body operable to be positioned in and connected with an air duct supplying air to an engine, said nozzle and said body being integral as a single casting.

According to a further aspect of the invention, there is provided an engine shutdown valve with a valve body having a solenoid operated gate movable between an unreleased position within said valve body wherein said gate is held in an open position and a released position within said valve body wherein said gate is in a closed position and a solenoid operable to be mounted to a land on said valve body so as to release said gate from said open position, said solenoid having a flange associated therewith, said land being integral with said valve body and said flange being operable to be connected directly to said flange.

According to yet a further aspect of the invention, there is provided a spindle assembly for an engine shutdown valve comprising a spindle having a first end operable to be engageable with a gate of said shutdown valve, a flange located a distance from said first end, a second end operably engageable with a plunger of a solenoid used for closing said gate of said shutdown valve, a spring with an inside diameter surrounding said spindle between said flange and said second end and a spacer operably positioned between said spring and said plunger, said spindle having an outside diameter between said flange and said second end relatively smaller than said inside diameter of said spring thereby to avoid contact between said outside diameter of said spindle and said inside diameter, said flange including a shoulder extending from said flange a distance within said inside diameter of said spring, said spacer having a shoulder extending towards said flange and within said inside diameter of said spring.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic plan view of two engine shutdown valves installed in the air supply ducts of a diesel engine according to a typical installation of the prior art;

FIGS. 2A and 2B are isometric views of a portion of an unassembled engine shutdown valve casting particularly illustrating the upstream and downstream nozzles being integral with the valve body according to one aspect of the invention;

FIG. 3 is an isometric view of a second unassembled portion of the engine shutdown valve of FIGS. 2A and 2B particularly illustrating the land to which a solenoid is attached according to a further aspect of the invention;

FIG. 4 is a diagrammatic partially sectional front view of the engine shutdown valve according to the invention particularly illustrating the spindle and solenoid assembly; and

FIG. 5 is a sectional and enlarged partial view of the engine shutdown valve according to the invention particularly illustrating the spindle assembly according to the invention.

### DESCRIPTION OF SPECIFIC EMBODIMENT

Referring now to the drawings, two air supply ducts 101 extend from and are downstream of respective turbo chargers (not shown) into each of which ambient air is introduced and which ambient air is then compressed and passed to an after cooler 103 used for cooling the heated and compressed air. The cooled air is then introduced into the diesel engine generally illustrated at 102 and used for combustion as is known.

An engine shutdown valve generally illustrated at 100 and constructed and installed according to the prior art is mounted in each of the air supply ducts 101. Each of the engine shutdown valves 100 is remotely operated using respective electrically operated solenoids 104 which each releases a gate (not illustrated) used to block the flow of air to the after cooler 103 and thence to the engine 102. By blocking or terminating air flow to the engine 102, there will be no air supplied for fuel combustion and the engine will shut down. Such engine shutdown valves are well known and extensively used for terminating operation of diesel engines, particularly large diesel engines which are used in locations where airborne hydrocarbons are present such as in oil and gas drilling and production operations.

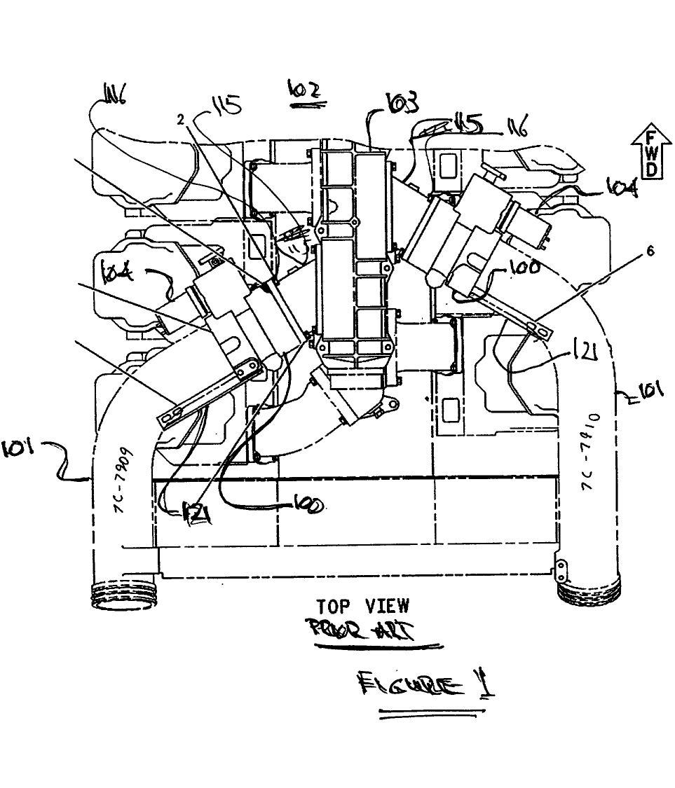

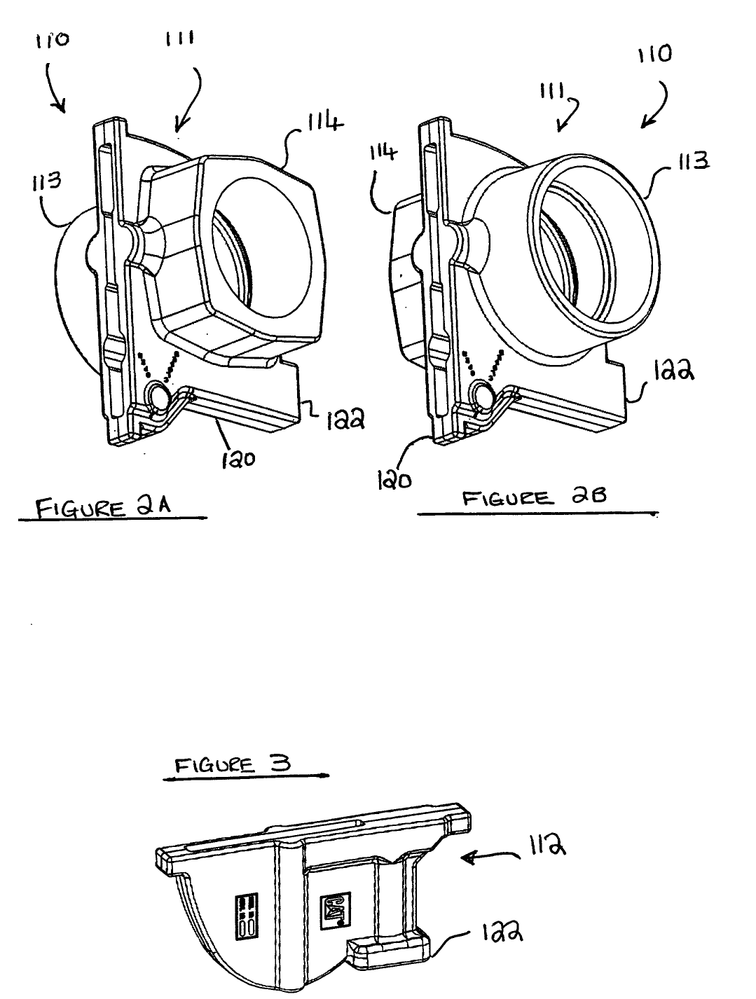

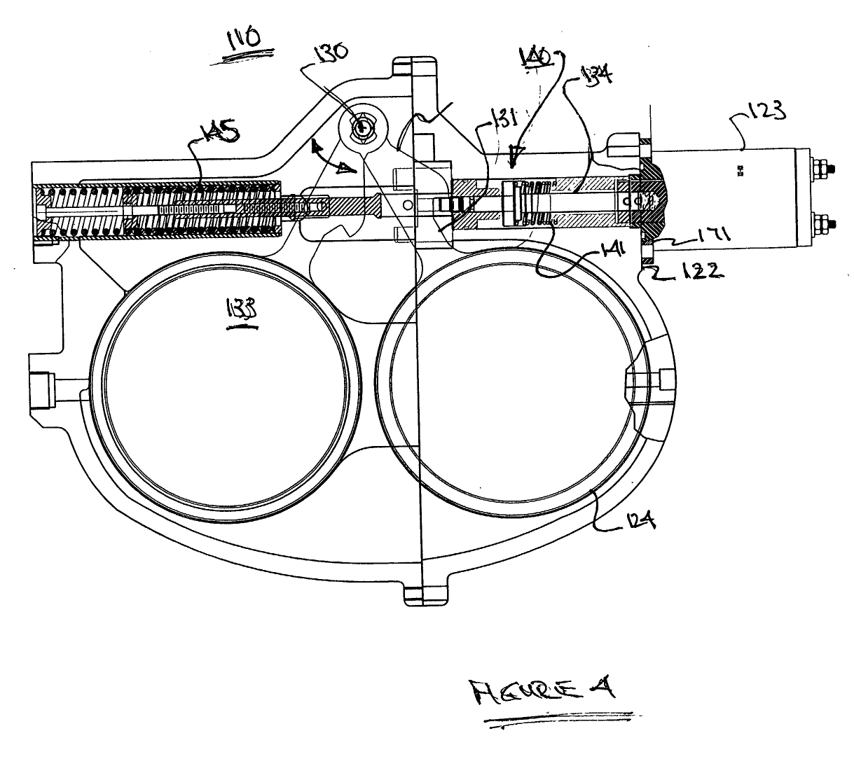

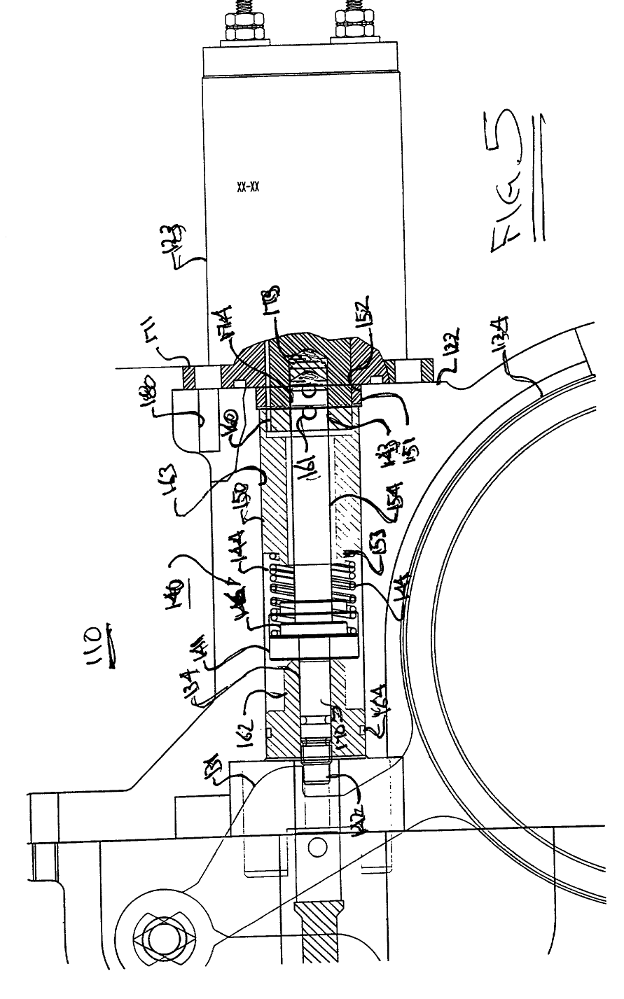

An assembled engine shutdown valve according to the present invention is generally illustrated at 110 in FIG. 4 and unassembled body portions 111, 112 are generally illustrated in FIGS. 2A, 2B and 3. Following insertion of the various internal components as will be described, body portion 112 is connected to body portion 111 and the assembly is operably installed in the air ducts 101 in the same way as illustrated in FIG. 1.

First and second nozzles 113, 114 extend from and are integral with the central portion 120 of the shutdown valve 110. The inlet air ducts 101 (FIG. 1) are inserted into nozzle 113 and maintained in position with clamps 121. Respective flanges 115 extend from the after cooler 103 and are mounted directly to nozzles 114 using bolts 116 to maintain the connection integrity.

A land 122 is integral with the central portion 120 of the shutdown valve 110. Land 122 is used for the direct connection of the solenoid 123 (FIG. 4) as will be described.

Reference is now made to FIG. 4 wherein the engine shutdown valve 110 according to the invention is illustrated in its assembled condition. A gate 124 rotates about axis 130 and has a gate arm 131 extending from axis 130 which gate arm 131 is connected to gate 124. Gate 124 is ordinarily held in its open position thereby allowing unimpeded air flow to the engine 102 through air duct opening 133. Gate 124 is held open by contact between the gate arm 131 and one end of a spindle 134 which is a component of the spindle assembly generally illustrated at 140. Following release of the gate 124 by movement of the spindle 134 and release of the gate arm 131, a compression spring 145 immediately provides the force necessary to move the gate 124 to its closed position by rotating the gate arm 131 and attached gate 124 clockwise about pivot axis 130 as viewed in FIG. 4. The closing action of the gate 124 by compression spring 145 is described in detail in our aforementioned patents and forms no part of the present invention.

The spindle assembly 140 and the attachment of the solenoid 123 to land 122 is shown more clearly in FIG. 5. The spindle assembly 140 comprises the spindle 134 with its attached flange 141 and its first and second ends 142, 143, respectively. End 142 is adapted for contact with gage arm 131 when the gate 124 is in its open position allowing unimpeded air flow through the engine shutdown valve 110. Flange 141 includes a shoulder 146 of a diameter which is such as to allow a compression spring 144 to be mounted thereover as will be described. A spacer 150 is likewise provided. Spacer 150 abuts the male protuberance 151 of solenoid 123 which protuberance 151 is adapted to be inserted into a machined recess 152 within engine shutdown valve 110. Spacer 150 likewise has a shoulder 153 machined therein which allows the end of compression spring 144 opposite from the end in contact with flange 141 to be mounted over the end of spacer 150. Spindle 134 further includes a longitudinal portion 154 which is connected at second end 143 to the plunger 160 of solenoid 123 by use of a pin 161. A compression spring 173 is mounted within the recess 174 of plunger 160 between the end 143 of spindle 134 thereby to remove any play between the pin 161, plunger 160 and spindle 134.

Longitudinal portion 154 of spindle 134 also has a diameter which is relatively considerably smaller than the inside diameter of compression spring 144 thereby to avoid any contact with spring 144 which contact could otherwise lessen or eliminate drag between the two caused by contact of the inside diameter of the spring 144 with the outside diameter of the longitudinal portion 154.

A guide bushing 162 is mounted within the spring assembly cavity 163 to allow for guided movement of the spindle 134 between the open and closed positions of gate 124. Guide bushing 162 has an o-ring 164 mounted therearound and a further o-ring 170 is mounted abut spindle 134, the purpose of both o-rings 164, 170 being for pneumatic sealing during engine operation.

Solenoid 123 is connected directly to land 122 and fasteners (not shown) provide for a tightened connection between the solenoid 123 and the land 122 of engine shutdown valve 110.

### Operation

In operation, it will be assumed that the engine shutdown valve 110 has been duly assembled with its internal components as illustrated in FIG. 4 and that the engine shutdown valve 110 has been installed between the air supply ducts 101 and the flange assemblies 115 in a manner similar to that shown in FIG. 1; that is, the air supply ducts 101 are inserted into nozzle 113 and maintained in position with clamps 121 and that the flanges 115 extending to the after cooler 103 have been connected directly to the nozzles 114 of shutdown valves 110.

The gate arm 131 will be in its most counterclockwise or open position as shown in FIG. 4 with first end 142 of spindle 134 in contact with the holding recess of gate arm 131 (FIG. 5). Solenoid 123 will be in its installed position as illustrated with its flange 171 directly connected to land 122 of engine shutdown valve 110 and maintained in its attached condition with bolts (not shown) threadedly mounted within connecting holes 180.

In the event of a safety problem or if it is otherwise in order to close the engine shutdown valve 134 and to terminate air flow to the engine 102, the solenoid 123 is operated either remotely by automatic operation if sensors sense an unsafe condition or manually by an operator. In either event, solenoid plunger 160 will move rightwardly as viewed in FIG. 5 together with attached spindle 134 through the connection with pin 161.

Spindle 134 will move within and relative to spacer 150 and compression spring 144 will be compressed between spacer 150 and flange 141 as flange 141 moves rightwardly with spindle 134. During that movement, it will be particularly noted that the inside diameter of spring 144 will avoid any contact with the longitudinal portion 154 of spindle 134 during movement of the spindle 134 and that the spring 144 is securely retained on shoulder 153 of spacer 150 and shoulder 146 of flange 141 thereby avoiding any possible entry of spring 144 into the circumferential recess between the outside diameter of longitudinal portion 154 of spindle 134 and the inside diameter of spacer 150.

As spindle 134 moves rightwardly, first end 142 will leave contact with gate arm 131 and gate arm 131, under the influence of compression spring 145, will immediately move clockwise as viewed in FIG. 4, to its closed position thereby terminating air flow to the engine 102 and shutting down the engine.

While the engine shutdown valve according to the invention has a shutdown operation that is triggered by an electrically controlled solenoid, it also is contemplated that hydraulic or pneumatic action may be utilised if the use of electricity is unsafe or otherwise proscribed.

Many further modifications may readily occur to those skilled in the art to which the invention relates and the specific embodiments described should be taken as illustrative of the invention only and not as limiting its scope as defined in accordance with the accompanying claims.

I claim:

1. An engine shutdown valve having a valve body with an air passage therein and at least one nozzle on one side of said valve body operable to be positioned in and connected with an air duct supplying air to an engine, said one nozzle and said valve body being integral as a single casting.

2. An engine shutdown valve as in claim 1 and further comprising a second nozzle on the side of said valve body opposite from said one side, said second nozzle being integral with said valve body and said one nozzle as said single casting.

3. An engine shutdown valve as in claim 2 and further comprising a solenoid operated gate movable between an unreleased position within said valve body wherein said gate is held in an open position and a released position within said valve body wherein said gate is in a closed position, and a land on said valve body having a face for direct connection to said solenoid, said solenoid further including a flange for direct contact with said land of said valve body.

4. An engine shutdown valve as in claim 3 and further comprising bolts connecting said flange of said solenoid with said land of said valve body.

5. An engine shutdown valve as in claim 3 and further comprising a spindle assembly, said spindle assembly including a spindle having a first end operable to be engageable with a gate of said shutdown valve, a flange located a distance from said first end, a second end operably engageable with a plunger of said solenoid, a spring having an inside diameter which spring surrounds said spindle between said flange and said second end and a spacer operably positioned between said spring and said plunger, said spindle having an outside diameter between said flange and said second end relatively smaller than said inside diameter of said spring thereby to avoid contact between said outside diameter of said spindle and said inside diameter of said spring, said flange including a shoulder extending from said flange a distance within said inside diameter of said spring, said spacer having a shoulder extending towards said flange and within said inside diameter of said spring.

6. An engine shutdown valve with a valve body having a solenoid operated gate movable between an unreleased position within said valve body wherein said gate is held in an open position and a released position within said valve body wherein said gate is in a closed position and a solenoid operable to be mounted to a land on said valve body so as to release said gate from said open position, said solenoid having a flange associated therewith, said land being integral with said valve body and said flange being operable to be connected directly to said flange.

7. An engine shutdown valve as in claim 6 and further comprising a spindle assembly, said spindle assembly comprising a spindle having a first end operable to be engageable with said gate, a flange located a distance from said first end, a second end operably engageable with a plunger of said solenoid, a spring with an inside diameter surrounding said spindle between said flange and said second end and a spacer operably positioned between said spring and said plunger, said spindle having an outside diameter between said flange and said second end relatively smaller than said inside diameter of said spindle and said inside diameter of said spring thereby to avoid contact between said outside diameter of said spindle and said inside diameter of said spring, said flange including a shoulder extending from said flange a distance within said inside diameter of said spring, said spacer having a shoulder extending towards said flange and within said inside diameter of said spring.

8. A spindle assembly for an engine shutdown valve comprising a spindle having a first end operable to be engageable with a gate of said shutdown valve, a flange located a distance from said first end, a second end operably engageable with a plunger of a solenoid used for closing said gate of said shutdown valve, a spring with an inside diameter surrounding said spindle between said flange and said second end and a spacer operably positioned between said spring and said plunger, said spindle having an outside diameter between said flange and said second end relatively smaller than said inside diameter of said spring thereby to avoid contact between said outside diameter of said spindle and said inside diameter, said flange including a shoulder extending from said flange a distance within said inside diameter of said spring, said spacer having a shoulder extending towards said flange and within said inside diameter of said spring.
